(19) United States
(12) Patent Application Publication
(10) Pub. No.: US 2023/0137867 A1
(43) Pub. Date: May 4, 2023

(54) GENERATING NON-FUNGIBLE TOKENS (NFTS) REPRESENTING DIGITAL ASSETS

(71) Applicant: Capital One Services, LLC, McLean, VA (US)

(72) Inventors: Austin WALTERS, Savoy, IL (US); Jeremy GOODSITT, Champaign, IL (US); Anh TRUONG, Champaign, IL (US); Galen RAFFERTY, Mahomet, IL (US); Brian BARR, Schenectady, NY (US); Samuel SHARPE, Cambridge, MA (US); Christopher WALLACE, Rochester, NY (US); Grant EDEN, Menlo Park, CA (US)

(73) Assignee: Capital One Services, LLC, McLean, VA (US)

(21) Appl. No.: 17/513,206

(22) Filed: Oct. 28, 2021

(51) Int. Cl. G06Q 20/12; G06Q 20/38; G06Q 40/04; G06Q 20/40; H04L 9/32

(52) U.S. Cl. CPC G06Q 20/1235; G06Q 20/389; G06Q 40/04; G06Q 20/3827; G06Q 20/401; H04L 9/3239; H04L 2209/38; G06F 16/27

(57) ABSTRACT

Disclosed herein are system, method, and computer program product embodiments for generating non-fungible tokens (NFTs) representing digital assets. In various embodiments, a server generates a first NFT comprising one or more hash values. Each hash value of the one or more hash values corresponds with at least one cryptographically verifiable asset of one or more cryptographically verifiable assets. The server further receives a first request to obtain a first portion of the first NFT for a user and determines a first value of the first NFT based on a crypto-value of each of the one or more cryptographically verifiable assets. The server generates a second NFT comprising a first NFT hash value, wherein a second value of the second NFT matches the first portion of the first value and issues the second NFT to the user.

### BACKGROUND

Users have increasingly started owning digital assets. These digital assets may be acquired through digital mechanisms, such as a website, web application, or the like. The confirmation of ownership is a soft copy confirmation or receipt. However, often the ownership of the digital assets may be unverifiable. For example, when acquiring a digital asset from an entity, a user may not determine whether the entity is the true owner of the digital asset. As such, users may be susceptible to fraud, inaccurate ownership records, and an inefficient transfer of ownership. Therefore, conventional systems provide an error-prone and inefficient system for owning and acquiring digital assets.

### BRIEF DESCRIPTION OF THE DRAWINGS

The accompanying drawings are incorporated herein and form a part of the specification.

FIG. 1 is a block diagram of a system for generating NFTs representing digital assets, according to some embodiments.

FIG. 2 is a block diagram illustrating the data flow in the system for generating NFTs representing digital assets, according to some embodiments.

FIG. 3 is a flowchart illustrating a process for generating an NFT, according to some embodiments.

FIG. 4 is a flowchart illustrating the process of generating an NFT representing a portion of a different NFT, according to some embodiments.

FIG. 5 is a flowchart illustrating a process for adjusting the value of an NFT, according to some embodiments.

FIG. 6 is a flowchart illustrating a process for generating a duplicative NFT, according to some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for generating NFTs representing digital assets.

As described above, when acquiring a digital asset from an entity, a user is unable to determine whether the entity is the true owner of the digital asset. As such, users may be susceptible to fraud, inaccurate ownership records, and an inefficient and ineffective transfer of ownership. Therefore, conventional systems provide an error-prone and inefficient system for owning and acquiring digital assets.

As a non-limiting example, such a problem exists when attempting to acquire digital assets such as Exchange-Traded Funds (ETB). ETEs are bundles of assets such as stocks, bonds, currencies, and/or commodities such as gold bars. Companies create “recipes” for the ETFs. A market maker will buy shares of the assets to be included in the ETF and create new shares, representing the sum of the shares of the assets. However, often, the market makers do not own the shares of the assets when the ETF is created. This leads to “naked shorting” or “synthetic shares.” That is, the market makers are selling ETFs that include shares of assets that they do not own. As such, when a user purchases a share of the ETF, it is unclear whether the user owns all the shares that are included in the ETF. As a result, the ownership of the ETF is unverifiable.

Embodiments described herein solve these present problems by generating non-fungible tokens (NFTs) representing digital assets. As NFTs are represented by blockchains, they provide verifiable proof of ownership. Specifically, a given NFT provides a “digital signature” that is used to track the ownership. Moreover, NFTs function as cryptographic tokens. Each NFT may be unique and may not be interchangeable. Furthermore, each NFT may represent a different asset. As a non-limiting example, NFTs have been used to represent digital media (e.g., art, audio files, video files, etc.).

In various embodiments, a server generates a first NFT comprising one or more hash values. Each hash value of the one or more hash values corresponds with at least one cryptographically verifiable asset of one or more cryptographically verifiable assets. The server further receives a first request to obtain a first portion of the first NFT for a user and determines a first value of the first NFT based on a crypto-value of each of the one or more cryptographically verifiable assets. The server generates a second NFT comprising a first NFT hash value, wherein a second value of the second NFT matches the first portion of the first value and issues the second NFT to the user.

The first and second NFTs are represented by a first blockchain, and the second NFT is represented by a second blockchain. Moreover, each cryptographically verifiable asset is represented by a blockchain.

The embodiments described herein provide for digital assets stored as cryptographically verifiable ledgers. Therefore, a user may track the ownership of the digital asset using the cryptographically verifiable ledger. As a result, the ownership and value of the digital asset are current and verifiable. This ensures that the digital asset has a measurable and verifiable intrinsic value. This eliminates any inefficiencies and uncertainties when owning digital assets.

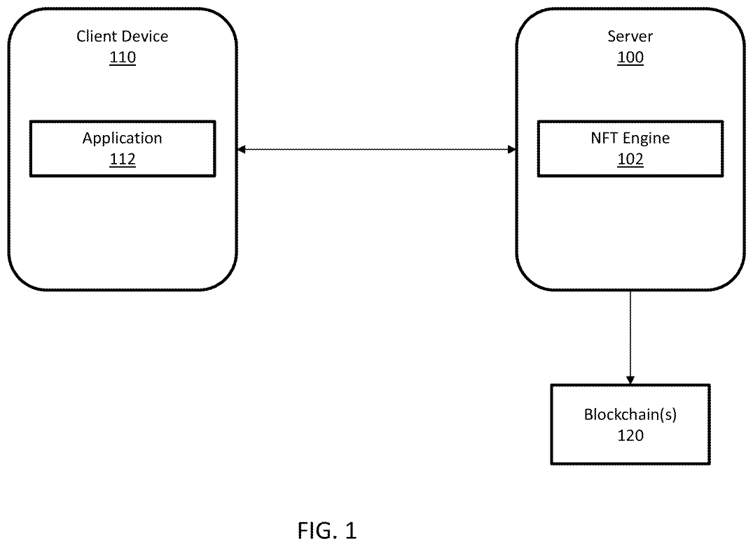

FIG. 1 is a block diagram of a system for generating NFTs representing digital assets, according to some embodiments. In an embodiment, the architecture may include server 100, client device 110, and blockchain(s) 120.

The devices in the architecture can be connected through wired connections, wireless connections, or a combination of wired and wireless connections. As an example, the devices can be connected through a network. The network can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

Server 100 may include NFT engine 102, and client device 110 may include application 112. Client device 110 may launch application 112 to interact with server 100. Application 112 may be a web-based application residing on client device 110. Alternatively, application 112 may be accessed via an Internet browser. A user may execute an action associated with an NFT representing a digital asset using application 112.

NFT engine 102 may be configured to execute actions associated with an NFT representing a digital asset. NFT engine 102 may execute the actions automatically or based on a request received from application 112. NFT engine 102 may be in communication with blockchain 120 to execute the action.

Blockchain 120 may be a distributed ledger represented by a sequence of blocks. Each block is generated in response to an event(s). Each block stores the data of the event(s), a timestamp of the block creation, and a hash value representing data of the previous block in the sequence of blocks. Multiple different computing nodes store a copy of the blockchain ledger. Each time an action (e.g., the addition of a new block) to the sequence of blocks is to be executed, the catalyst event is broadcast to each of the computing nodes. The computing nodes verify the event based on the data stored in their copy of the blockchain ledger. In response to verification of the event from the computing nodes, the action to the sequence of blocks is executed.

Blockchain 120 may represent an NFT which represents a collection of digital assets. The collection of digital assets includes one or more cryptographically verifiable assets. Each cryptographically verifiable asset may also be represented by blockchain 120. Additionally, blockchain 120 may represent portions of the NFT.

For example, the distributed ledger corresponding to blockchain 120 may be distributed to multiple different computing nodes. Each computing node may store a copy of the distributed ledger. The computing nodes may be a network/collection of computing nodes assigned to receive a copy of the disturbed ledger by an entity that created the NFT. To this end, the entity may be a financial institution. The financial institution may assign or designate the computing nodes to receive the distributed ledger.

The distributed ledger may store each event that occurs with the NFT. For example, an event may occur when an NFT is modified, value changes, part or all of it is obtained by a user, part or all of it divested by a user, etc. The details of each event may be verified by each of the computing nodes. The computing nodes may verify the accuracy of the details. Furthermore, each computing node may provide additional details related to the event. The event is only added to the distributed ledger once it is verified. This ensures that the details or data associated with each event are accurate.

Each event may be tied to a timestamp indicating when the event occurred and/or when the event was verified by the computing nodes. For example, if the NFT is modified on Oct. 20, 2021, at 1300, the timestamp may be 2021:10:21 13:00:30. Other timestamps may be supported. As indicated above, each block in blockchain 120 may correspond with an event. As such, each block is generated in blockchain 120 in chronological order of the event occurring or being verified based on the timestamp.

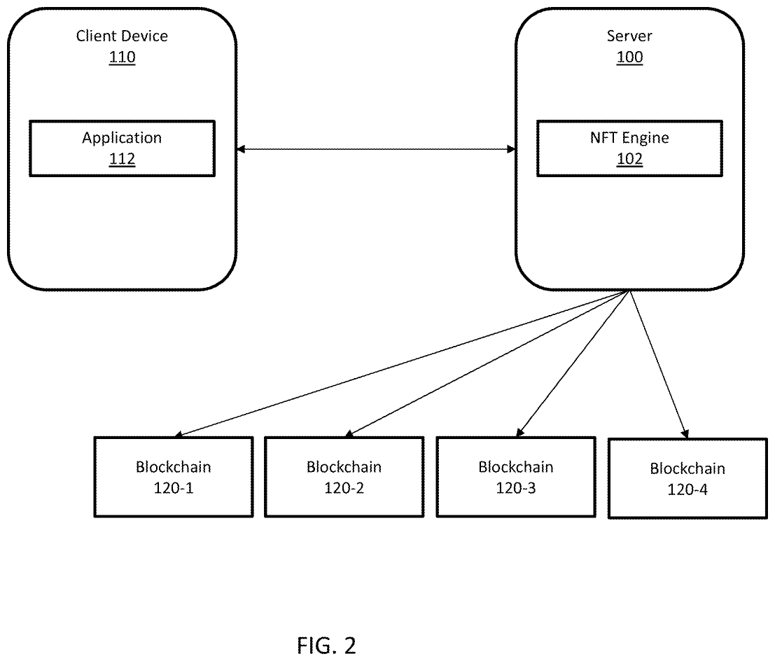

FIG. 2 is a block diagram illustrating the data flow in the system for generating NFTs representing digital assets, according to some embodiments. As described with respect to FIG. 1, the system for generating NFTs representing digital assets includes server 100 and client device 110. The system may also include blockchains 120-1-120-7.

Blockchain 120-1 may represent a first cryptographically verifiable asset. Blockchain 120-2 may represent a second cryptographically verifiable asset. As a non-limiting example, the first or second cryptographically verifiable asset may be cryptocurrencies. Cryptocurrency may be a monetary currency stored in a blockchain system such as blockchain 120-1 or blockchain 120-2. Blockchain 120-1 and 120-2 may be managed by a third-party entity 200 who may be responsible for issuing cryptographically verifiable assets.

In various embodiments, blockchain 120-1 or 120-2 may be a collection of cryptographically verifiable assets. The collection of cryptographically verifiable assets may be a “wallet,” including different portions of individual cryptographically verifiable assets (e.g., cryptocurrencies).

NFT engine 102 may generate a first NFT. In various embodiments, NFT engine 102 generates the first NFT in response to receiving a request from an entity responsible for generating and managing NFTs (e.g., financial institution, company, corporation, organization, etc.). The request may be an HTTP request. The request may include a desired value of the NFT, identifiers of cryptographically verifiable assets to be acquired (e.g., the first cryptographically verifiable asset and the second cryptographically verifiable asset), portions of cryptographically verifiable assets to be acquired, desired date and/or time to acquire the cryptographically verifiable assets, etc.

NFT engine 102 generates the first NFT by acquiring one or more portions of the first cryptographically verifiable asset and the second cryptographically verifiable asset. Specifically, NFT engine 102 may transmit a request to an entity managing blockchain 120-1 and 120-2. The request may include the identifiers of cryptographically verifiable assets to be acquired (e.g., the first cryptographically verifiable asset and the second cryptographically verifiable asset), portions of cryptographically verifiable assets to be acquired, desired date and/or time to acquire the cryptographically verifiable assets, etc. To this end, NFT engine 102 may acquire shares, cryptocurrency, or the value of the first and second cryptographically verifiable assets.

NFT engine 102 may acquire the desired portions of the first and second cryptographically verifiable assets as digital assets. As such, NFT engine 102 may receive electronic files that include private keys indicating access or ownership of the respective portions of the first or second cryptographically verifiable assets. NFT engine 102 may receive the electronic files as hot wallets or cold wallets. A hot wallet may be electronic files that include private keys indicating access or ownership of the respective portions of the first or second cryptographically verifiable assets that are stored online. A cold wallet may be a copy of the electronic files that include private keys indicating access or ownership of the respective portions of the first or second cryptographically verifiable assets stored locally.

In response to acquiring the one or more portions of the first and second cryptographically verifiable assets, blockchain 120-1 and 120-2 may generate new blocks in their respective sequence of blocks. The new blocks may include the event (e.g., acquiring of the one or more portions by NFT engine 102) and a hash value of the previous block. NFT engine 102 may receive the hash values of the new blocks from blockchain 120-1 and 120-2.

The first NFT may be represented by blockchain 120-3. In response to generating the first NFT, NFT engine 102 may instruct blockchain 120-3 to generate a first new block for its sequence of blocks. The first new block may include the electronic files that include private keys indicating access or ownership of the respective portions of the first or second cryptographically verifiable assets. Furthermore, the first new block may include hash values of the new blocks generated in blockchain 120-1 and 120-2. As such, the first new block of blockchain 120-3 may store the ownership data of the one or more portions of blockchain 120-1 and 120-2.

The value of the first NFT may be equal to the combination of the values of the one or more portions of the first and second cryptographically verifiable assets. For example, if the first NFT includes portions of the first cryptographically verifiable asset valued at $500 and portions of the second cryptographically verifiable assets valued at $200, the first NFT may be valued at $700. The first new block in blockchain 120-3 may store the value of the first NFT. NFT engine 102 may divide the first NFT into a predetermined amount of shares. Each share may represent the percentage of the value of the first NFT.

In various embodiments, the value of the first and second cryptographically verifiable assets may fluctuate. As a result, the value of the first NFT may fluctuate as well. Each time the value changes, a new block in blockchain 120-3 is generated, indicating the new value. NFT engine 102 may monitor the value of the first NFT based on the most current block of blockchain 120-3. The entity responsible for managing the first NFT may want to maintain the first NFT at a predetermined value. The entity may transmit a request to server 100 to maintain the first NFT at the predetermined value.

In response to the value fluctuating more than a threshold amount, NFT engine 102 adjusts the value of the first NFT. For example, the entity managing the first NFT may desire to maintain the value of the first NFT at $700-$750. However, NFT engine 102 may determine that the value of the first NFT is now $600 because the value of the portions of the first cryptographically verifiable assets in the first NFT is has dropped from $500 to $400.

In light of this, NFT engine 102 may acquire additional portions of first or second cryptographically verifiable assets to maintain the predetermined value. In the above example, NFT engine 102 may transmit a request to the entity managing the first and second cryptographically verifiable assets to acquire additional portions of the first or second cryptographically verifiable assets valued at $100. NFT engine 102 may receive electronic files, including the private keys of the additional portions of the first or second cryptographically verifiable assets.

Alternatively, NFT engine 102 may sell or divest one or more portions of the first or second cryptographically verifiable assets to maintain the predetermined value. NFT engine 102 may also purchase or sell/divest other portions of other cryptographically verifiable assets to maintain the predetermined value.

NFT engine 102 may generate a new block in blockchain 120-3. Specifically, NFT may generate new or additional blocks in blockchains 120-1-120-7 by broadcasting the event (e.g., acquiring or selling/divesting cryptographically verifiable assets) to the computing nodes (as described above with respect to FIG. 1). One of the computing nodes may generate additional blocks in response to acquiring or selling/divesting cryptographically verifiable assets. The additional blocks may add hash values of blocks corresponding to additional cryptographically verifiable assets that have been acquired. Furthermore, the additional blocks may include the electronic files, including the private keys of the additional portions of the first or second cryptographically verifiable assets. Alternatively, the additional blocks may remove hash values of blocks corresponding to cryptographically verifiable assets that have been sold/divested. The additional blocks may include the latest value of the first NFT. For example, the latest value may be $700 after adding the portions of the first or second cryptographically verifiable assets valued at $100.

A user may interact with application 112 to acquire a portion of the first NFT. For example, the user may interact with application 112 such that application 112 transmits a request to server 100. The request may be for acquiring a portion of the first NFT. The portion may be represented by shares, percentage, value, etc. For example, a user may interact with application 112 to acquire 10% of the value of the first NFT. To this end, 10% of the first NFT may be $70.

NFT engine 102 may generate a second NFT, including the portion of the first NFT (e.g., 10%). Specifically, NFT engine 102 may acquire the portion of the first NFT out of the predetermined amount of shares of the NFT. The value of the second NFT may equal the value of the portion of the first NFT. For example, the value of the second NFT may include portions of the first and second cryptographically verifiable assets equal to 10% of the value of the first NFT.

In response to acquiring the portion, NFT engine 102 may generate a second new block in blockchain 120-3 as described above. The second new block may include the event details of the generation of the second NFT and the portion acquired for the second NFT. The most current block of blockchain 120-3 may also indicate the number of remaining shares of the first NFT (e.g., 90% shares may be remaining after 10% of shares have been acquired). Each time a portion of the first NFT is acquired, the number of remaining shares may decrease based on the size of the acquired portion.

The second NFT is represented by blockchain 120-4. In response to generating the second NFT, NFT engine 102 may generate a first new block in blockchain 120-4 as described above. The first new block of blockchain 120-4 may include a hash value of the second new block created in the blockchain 120-3. The first new block may also include electronic files, including the private keys indicating access or ownership of the respective portion of the first NFT. The first new block in blockchain 120-4 may also include the value of the second NFT and a user identifier of the user acquiring the second NFT.

NFT engine 102 may transmit a message with details about the second NFT to application 112. The message may include electronic files, including the private keys indicating access or ownership of the respective portion of the first NFT. The details may also include the hash value of the first new block of blockchain 120-4, the value of the second NFT, portions of the cryptographically verifiable assets included in the second NFT, etc. The message may indicate that the NFT engine 102 has issued the second NFT to the user.

In various embodiments, server 100 may receive a second request to acquire a portion of the first NFT. NFT engine 102 may identify the number of remaining shares of the first NFT based on the number of shares indicated in the second new block of blockchain 120-3 of blockchain 120-3. NFT engine 102 may determine that the remaining shares of the first NFT are less than the requested portion based on the remaining shares indicated in the second new block of blockchain 120-3. For example, if the second new block indicates that 20% of shares of the first NFT are available and the second request indicates a request to acquire 30% of the shares, NFT engine 120-3 may determine that the remaining shares of the first NFT are less than the requested portion based on the remaining shares indicated in the second new block of blockchain 120-3.

In this scenario, NFT engine 102 may attempt to increase the value of the first NFT so that an additional portion of the first NFT may be issued to the different users. NFT engine 102 may adjust the value of the first NFT such that the additional value added to the first NFT is greater than or equal to the requested portion. For example, NFT engine 102 may acquire additional portions of the first or second cryptographically verifiable assets, as described above. Blockchain 120-1 and 120-2 may generate additional blocks indicating NFT engine 102 acquiring the additional portions of the first and second cryptographically verifiable assets.

NFT engine 102 may generate a third new block in blockchain 120-3, as described above. The third new block includes hash values of the additional blocks in blockchain 120-1 and 120-2, indicating NFT engine 102 acquiring the additional portions of the first and second cryptographically verifiable assets. The third new block may also include the electronic files, including the private keys that indicate the access or ownership to the additional portions of the first and second cryptographically verifiable assets.

NFT engine 102 may generate a third NFT for the requested portion. The third NFT may be represented by blockchain 120-5. NFT engine 102 may generate a first new block in blockchain 120-5, as described above. The first new block may include the hash value of the third new block in blockchain 120-3, a value of the third NFT, and the user identifier. The first new block may also include the electronic files, including the private keys that indicate the access or ownership to the portion of the first NFT. NFT engine 102 may transmit a message to application 112 indicating that the third NFT has been issued to the different user. The message may include the hash value of the first new block of blockchain 120-5, the value of the third NFT, portions of the cryptographically verifiable assets included in the second NFT, electronic files including the private keys that indicate the access or ownership to the portion of the first NFT, etc.

Alternatively, in the event NFT engine 102 determines that the remaining shares of the first NFT are less than the requested portion based on the remaining shares indicated in the second new block of blockchain 120-3, NFT engine 102 may acquire additional portions of the first and second cryptographically verifiable assets to generate a fourth NFT represented by blockchain 120-6. For example, NFT engine 102 may acquire additional portions of the first and second cryptographically verifiable assets, as described above. NFT engine 102 may receive electronic files, including the private keys indicating ownership or access to the additional portions of the first and second cryptographically verifiable assets. The value of the additional portions of the first and second cryptographically verifiable assets may be equal to the value of the first NFT. As such, the first NFT and the fourth NFT may include the same value of portions of the first and second cryptographically verifiable assets. For example, if the value of the first NFT is $700, the value of the portions of the first and second cryptographically verifiable assets in the fourth NFT may collectively equal $700.

In response to acquiring the additional portions of the first and second cryptographically verifiable assets, blockchain 120-1 and blockchain 120-2 may generate additional blocks indicating the issuance of the additional portions. NFT engine 102 may generate a first new block in blockchain 120-6, as described above. The first new block includes the hash values of the additional blocks of blockchain 120-1 and blockchain 120-2. The first new block of blockchain 120-6 may include the value of the fourth NFT. NFT engine 102 may divide the fourth NFT into multiple shares. The most current block of the fourth NFT may include the number of shares remaining of the fourth NFT. Furthermore, the first new block may include the electronic files, including the private keys indicating access or ownership of the additional portions of the first and second cryptographically verifiable assets.

NFT engine 102 generates a fifth NFT by acquiring the requested portion of the fourth NFT. In response to acquiring the requested portion, blockchain 120-6 may generate a second new block indicating the generation of the fifth NFT and the remaining shares of the fourth NFT.

The fifth NFT may be represented by blockchain 120-7. In response to the generation of the fifth NFT, NFT engine 102 may generate a first new block in blockchain 120-7, as described above. The first new block may include a hash value of the second new block of blockchain 120-6, a value of the fifth NFT, and a user identifier of the different user. Furthermore, the first new block may include the electronic files, including the private keys indicating access or ownership of the portion of the fourth NFT.

NFT engine 102 may transmit a message to application 112 indicating that the fifth NFT has been issued to the different user. The message may include the hash value of the first new block of blockchain 120-7, the value of the fifth NFT, portions of the cryptographically verifiable assets included in the second NFT, the electronic files including the private keys indicating access or ownership of the portion of the fourth NFT, etc.

The various embodiments described herein allow for a secure and verifiable way to acquire and divest digital assets. Specifically, the various embodiments described herein allow for adjusting the values of creating NFTs, acquiring portions of NFTs, existing NFTs, and creating new NFTs, such that the ownership and value of the digital asset are current and verifiable. This ensures that the digital asset has a measurable and verifiable intrinsic value.

In various embodiments, a user may divest or sell their NFTs interacting with application 112. For example, application 112 may transmit a request to server 100 to sell or divest all or a portion of the second NFT. As described above, the second NFT may be a portion of the value of the first NFT.

NFT engine 102 may instruct blockchain 120-4 to generate a second new block. The second new block may remove the hash value of the second new block of blockchain 120-3. This may indicate that the second NFT has no value, as it has been sold or divested.

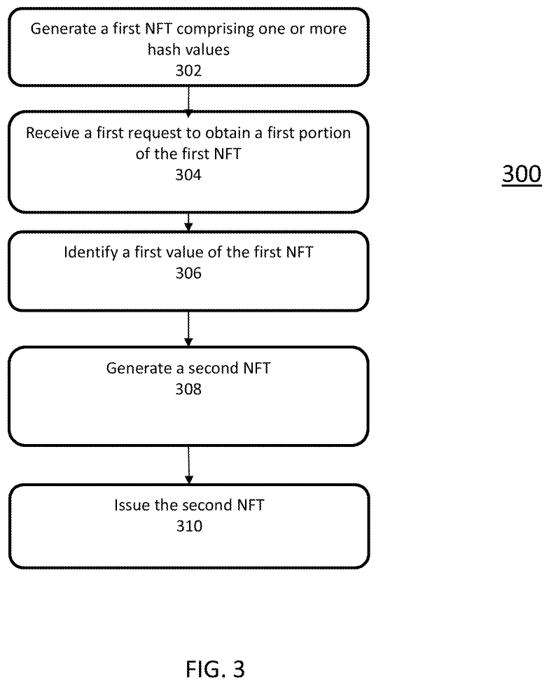

FIG. 3 is a flowchart illustrating a process for generating an NFT, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 3, as will be understood by a person of ordinary skill in the art.

Method 300 shall be described with reference to FIGS. 1-2. However, method 300 is not limited to that example embodiment.

In 302, NFT engine 102 of server 100 generates a first NFT comprising one or more hash values. The first NFT is a collection of portions of one or more cryptographically verifiable assets. For example, the first NFT may be a digital asset with a value that equals the values of the one or more cryptographically verifiable assets combined. Each hash value corresponds with at least one cryptographically verifiable asset of one or more cryptographically verifiable assets. The first NFT may be represented by blockchain 120-3. Blockchain 120-3 may include a block including one or more hash values of the cryptographically verifiable assets. The block may also include private keys of the portions of the one or more cryptographically verifiable assets.

In 304, NFT engine 102 receives a request to obtain a portion of the first NFT for a user. The request may be received from application 112. The request may include the desired value, an identifier of the first NFT, and a desired date and time to acquire the portion of the first NFT. The portion may be represented by shares, percentages, value, etc.

In 306, NFT engine 102 determines a first value of the first NFT based on a crypto-value of each of the one or more cryptographically verifiable assets. The first value may be a combination of the crypto-value of each of the one or more cryptographically verifiable assets. In one example, the cryptographically verifiable assets may be cryptocurrency. For example, the first NFT may include portions of a first cryptographically verifiable asset with a value of $500 and portions of a second cryptographically verifiable asset with a value of $200. As such, NFT engine 102 may determine that the value of the first NFT is $700. The most current (e.g., last) block of blockchain 120-3 may include the value of the first NFT.

In 308, NFT engine 102 generates a second NFT comprising the first NFT hash value. The second NFT may be of a second value that is a portion of the first value. That is, the second NFT may be made up of a portion of the cryptographically verifiable assets equal to the requested portion. For example, if the requested portion is 10% of the first NFT, the value of the second NFT may be $70. Moreover, the second NFT may be represented by blockchain 120-4. Blockchain 120-4 may include a hash value of the first NFT (e.g., blockchain 120-3). For example, blockchain 120-4 may include a block including the hash value of the first NFT. Furthermore, the block may include private keys indicating ownership of the portion of the first NFT.

In 310, NFT engine 102 issues the second NFT to the user. NFT engine 102 may transmit a message to application 112. The message may include the hash value of the second NFT (e.g., blockchain 120-4), the value of the second NFT, portions of the cryptographically verifiable assets included in the second NFT, etc. The message may include the private keys that indicate ownership of the portion of the requested portion of the first NFT.

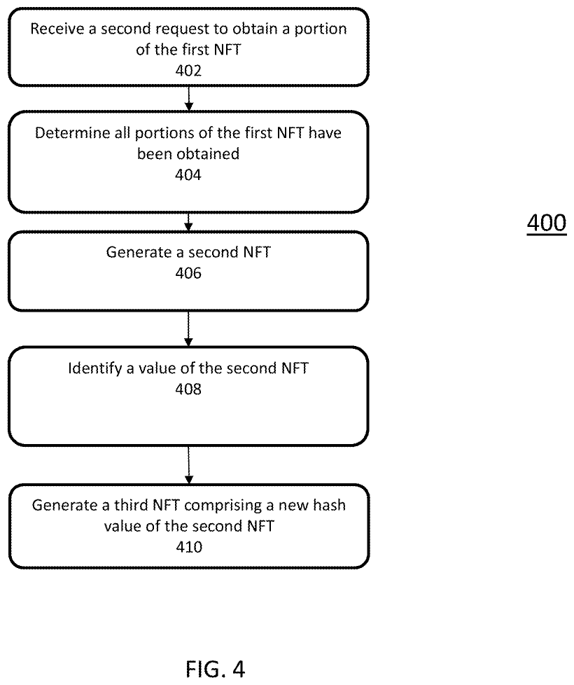

FIG. 4 is a flowchart illustrating the process of generating an NFT representing a portion of a different NFT, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 4, as will be understood by a person of ordinary skill in the art.

Method 400 shall be described with reference to FIGS. 1-2. However, method 400 is not limited to that example embodiment.

In 402, NFT engine 102 of server 100 receives a request to obtain a portion of a first NFT from a user. The request may include the desired value or portion of the first NFT, an identifier of the first NFT, and the date and time to obtain the portion of the first NFT. The first NFT may be represented by blockchain 120-3. Blockchain 120-3 includes one or more hash values of the one or more cryptographically verifiable assets. The first NFT may be generated as described in method 300 of FIG. 3.

In 404, NFT engine 102 determines that all portions of the first NFT have been obtained. The last/most current block of blockchain 120-3 may indicate the remaining portions or shares of the first NFT. NFT engine 102 may poll blockchain 120-3 to determine the remaining portions in the last/most current block of blockchain 120-3.

In 406, NFT engine 102 generates a second NFT. In this example, the second NFT may be represented by blockchain 120-6. NFT engine 102 acquires additional portions of the one or more cryptographically verifiable assets included in the first NFT. Blockchain 120-6 includes one or more additional hash values of the additional portions of the one or more cryptographically verifiable assets. For example, NFT engine 102 may acquire additional portions of one or more cryptographically verifiable assets with the same value as the one or more cryptographically verifiable assets in the first NFT. As such, the value of the second NFT may be the same as the value of the first NFT. Blockchain 120-6 may include a block including the one or more additional hash values of the additional portions of the one or more cryptographically verifiable assets. Furthermore, the block may include private keys of the additional portions of the one or more cryptographically verifiable assets.

In 408, NFT engine 102 generates a third NFT. In this example, the third NFT may be represented by blockchain 120-7. Blockchain 120-7 includes a hash value of the second NFT. Blockchain 120-7 indicates that the third NFT is of a value equal to the requested portion. For example, blockchain 120-7 includes a block including the hash value of the second NFT. Furthermore, the block includes private keys of the acquired portion of the second NFT.

In 410, NFT engine 102 issues the third NFT to the user. NFT engine 102 may transmit a message to application 112. The message may include the hash value of the third NFT (e.g., blockchain 120-7), the value of the third NFT, portions of the cryptographically verifiable assets included in the third NFT, private keys of the acquired portion of the second NFT, etc.

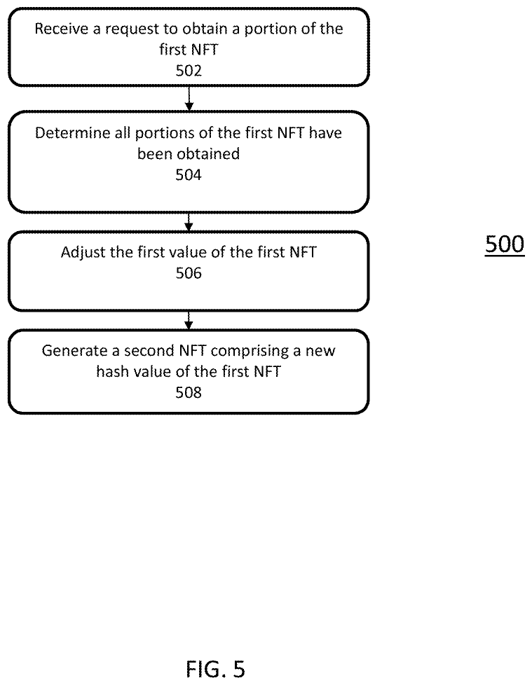

FIG. 5 is a flowchart illustrating a process for adjusting the value of an NFT, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 5, as will be understood by a person of ordinary skill in the art.

Method 500 shall be described with reference to FIGS. 1-2. However, method 500 is not limited to that example embodiment.

In 502, NFT engine 102 of server 100 receives a request to obtain a portion of a first NFT from a user. The request may include the desired value or portion of the first NFT, an identifier of the first NFT, and the date and time to obtain the portion of the first NFT. The first NFT may be represented by blockchain 120-3. Blockchain 120-3 includes one or more hash values of the one or more cryptographically verifiable assets. The first NFT may be generated as described in method 300 of FIG. 3.

In 504, NFT engine 102 determines that all portions of the first NFT have been obtained. The last/most current block of blockchain 120-3 may indicate the remaining portions or shares of the first NFT. NFT engine 102 may poll blockchain 120-3 to determine the remaining portions in the last/most current block of blockchain 120-3.

In 506, NFT engine 102 adjusts the first value of the first NFT by adding additional hash values of additional cryptographically verifiable assets in the first NFT such that the first value of the first NFT increases by an amount equal to the second portion. For example, the value of the requested portion may be $200. The value of the first NFT may be $700. In view of this, NFT engine 102 may acquire additional cryptographically verifiable assets that are greater than or equal to $200. Blockchain 120-3 may include the one or more additional hash values. Furthermore, blockchain 120-3 may include a block that includes private keys of the additional hash values.

In 508, NFT engine 102 generates a second NFT. In this example, the second NFT may be the requested portion of the first NFT. The second NFT may be represented by blockchain 120-5. The second NFT may be a value that may equal the requested portion. As such, blockchain 120-5 includes a hash value of the first NFT. Furthermore, blockchain 120-5 may include the private keys of the acquired portion of the first NFT.

In 510, NFT engine 102 issues the second NFT to the user. NFT engine 102 may transmit a message to application 112. The message may include the hash value of the second NFT (e.g., blockchain 120-5), the value of the second NFT, portions of the cryptographically verifiable assets included in the second NFT, private keys of the acquired portion of the first NFT, etc.

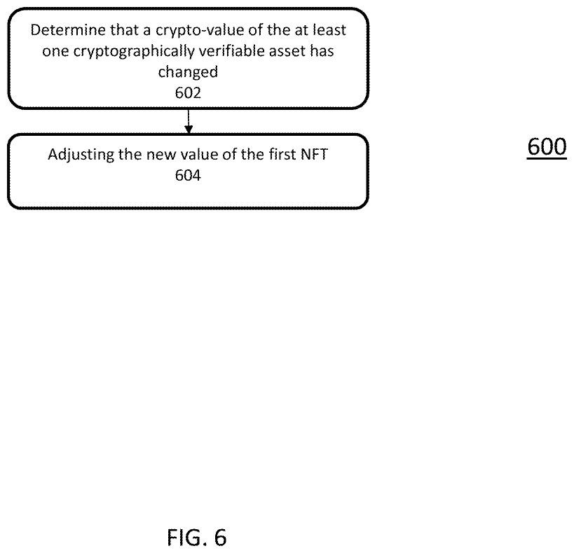

FIG. 6 is a flowchart illustrating a process for generating a duplicative NFT, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 6, as will be understood by a person of ordinary skill in the art.

Method 600 shall be described with reference to FIGS. 1-2. However, method 600 is not limited to that example embodiment.

In 602, NFT engine 102 of server 100 determines that a crypto value of at least one cryptographically verifiable asset has changed such that a value of a first NFT is updated to a new value. The first NFT may be generated as described in method 300 of FIG. 3. The first NFT may be represented by blockchain 120-3. Blockchain 120-3 includes one or more hash values of the one or more cryptographically verifiable assets. Blockchain 120-3 includes one or more hash values of the one or more cryptographically verifiable assets. For example, NFT engine 102 may poll the last/current block of blockchain 120-3 to determine that the current value of the first NFT has changed from $700 to $600. The first NFT may be generated as described in method 300 of FIG. 3.

In 604, NFT engine 102 adjusts the new value of the first NFT by adding additional hash values of additional cryptographically verifiable assets in the first NFT or removing at least one hash value of a cryptographically verifiable asset from the first NFT, such that new value is adjusted to equal the original value of the first NFT. For example, NFT engine 102 may acquire additional portions of cryptographically verifiable assets that correspond to the additional hash values. This may result in increasing the new value to the original value of the first NFT. Blockchain 120-3 may include the additional hash values. Moreover, blockchain 120-3 may include a block with the private keys of the additional portions of the cryptographically verifiable assets. For example, the additional portions of the cryptographically verifiable ledger may be of a value of $100. As such, by adding acquiring the additional portions, the value of the first NFT may increase from $600 to $700. Alternatively, NFT engine 102 may remove the one or more hash values from blockchain 120-3. This may result in reducing the value of the new value to the original value of the first NFT.

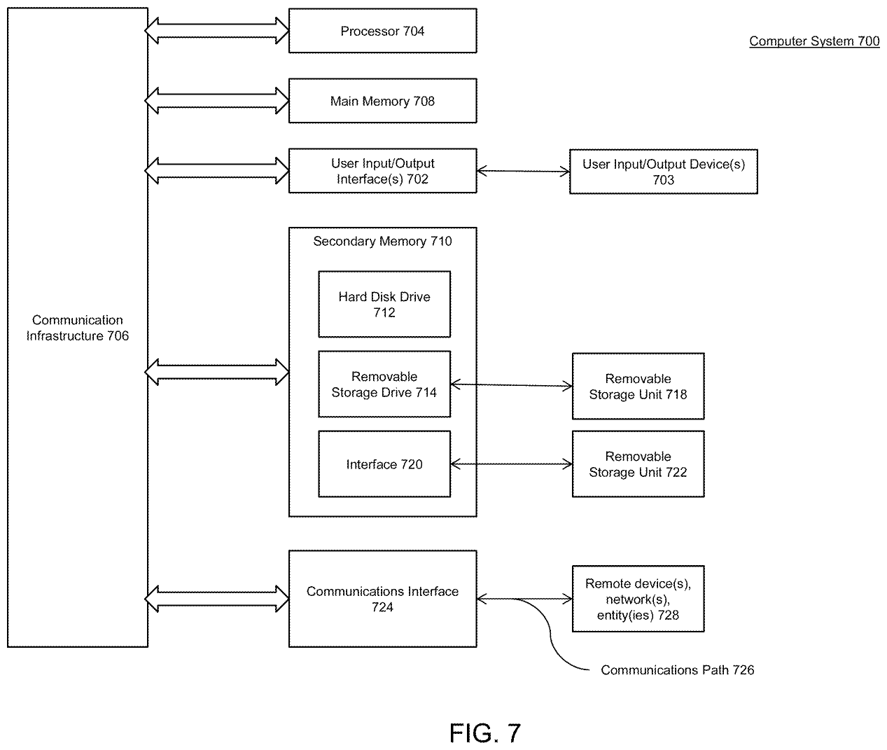

Various embodiments can be implemented, for example, using one or more computer systems, such as computer system 700 shown in FIG. 7. Computer system 700 can be used, for example, to implement methods 300 of FIG. 3, 400 of FIG. 4, 500 of FIGS. 5, and 600 of FIG. 6. Furthermore, computer system 700 can be at least part of server 100, target system 130, data model 122, and event infrastructure 140, as shown in FIG. 1. For example, computer system 700 route communication to various applications. Computer system 700 can be any computer capable of performing the functions described herein.

Computer system 700 can be any well-known computer capable of performing the functions described herein.

Computer system 700 includes one or more processors (also called central processing units, or CPUs), such as a processor 704. Processor 704 is connected to a communication infrastructure or bus 706.

One or more processors 704 can each be a graphics processing unit (GPU). In an embodiment, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702.

Computer system 700 also includes a main or primary memory 708, such as random access memory (RAM). Main memory 708 can include one or more levels of cache. Main memory 708 has stored therein control logic (i.e., computer software) and/or data.

Computer system 700 can also include one or more secondary storage devices or memory 710. Secondary memory 710 can include, for example, a hard disk drive 712 and/or a removable storage device or drive 714. Removable storage drive 714 can be a floppy disk drive, a magnetic tape drive, a compact disk drive, an optical storage device, tape backup device, and/or any other storage device/drive.

Removable storage drive 714 can interact with a removable storage unit 718. Removable storage unit 718 includes a computer usable or readable storage device having stored thereon computer software (control logic) and/or data. Removable storage unit 718 can be a floppy disk, magnetic tape, compact disk, DVD, optical storage disk, and/any other computer data storage device. Removable storage drive 714 reads from and/or writes to removable storage unit 718 in a well-known manner.

According to an exemplary embodiment, secondary memory 710 can include other means, instrumentalities, or other approaches for allowing computer programs and/or other instructions and/or data to be accessed by computer system 700. Such means, instrumentalities, or other approaches can include, for example, a removable storage unit 722 and an interface 720. Examples of the removable storage unit 722 and the interface 720 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 can further include a communication or network interface 724. Communication interface 724 enables computer system 700 to communicate and interact with any combination of remote devices, remote networks, remote entities, etc. (individually and collectively referenced by reference number 728). For example, communication interface 724 can allow computer system 700 to communicate with remote devices 728 over communications path 726, which can be wired and/or wireless, and which can include any combination of LANs, WANs, the Internet, etc. Control logic and/or data can be transmitted to and from computer system 700 via communication path 726.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other but yet still co-operate or interact with each other.

The breadth and scope of this disclosure should not be limited by any of the above-described exemplary embodiments, but should be defined only in accordance with the following claims and their equivalents.

What is claimed is:

1. A method for generating non-fungible tokens (NFTs) representing digital assets, the method comprising:
generating, by one or more computing devices, a first NFT comprising one or more hash values, each hash value of the one or more hash values corresponding with at least one cryptographically verifiable asset of one or more cryptographically verifiable assets;
receiving, by the one or more computing devices, a first request to obtain a first portion of the first NFT for a user;
determining, by the one or more computing devices, a first value of the first NFT based on a crypto-value of each of the one or more cryptographically verifiable assets;
generating, by the one or more computing devices, a second NFT comprising a first NFT hash value, wherein a second value of the second NFT matches the first portion of the first value; and
issuing, by the one or more computing devices, the second NFT to the user.

2. The method of claim 1, wherein the first NFT is represented by a first blockchain and the second NFT is represented by a second blockchain.

3. The method of claim 2, wherein the second blockchain indicates that the second value of the second NFT is equal to the first portion of the first NFT.

4. The method of claim 1, further comprising adjusting, by the one or more computing devices, the value of the first NFT by adding additional hash values of additional cryptographically verifiable assets to the first NFT or removing at least one hash value of a cryptographically verifiable asset from the first NFT.

5. The method of claim 1, further comprising:
receiving, by the one or more computing devices, a second request to obtain a second portion of the first NFT from a different user;
determining, by the one or more computing devices, all portions of the first NFT have been obtained;
generating, by the one or more computing devices, a third NFT comprising the one or more additional hash values of the one or more cryptographically verifiable assets included in the first NFT, wherein the third NFT is of a third value and the third value matches the first value;
generating, by the one or more computing devices, a fourth NFT comprising a third NFT hash value, wherein a fourth value of the fourth NFT is the second portion of the third value; and
issuing, by the one or more computing devices, the fourth NFT to the different user.

6. The method of claim 1, further comprising:
receiving, by the one or more computing devices, a second request to obtain a second portion of the first NFT from a different user;
determining, by the one or more computing devices, all portions of the first NFT have been obtained;
adjusting, by the one or more computing devices, the first value of the first NFT by adding additional hash values of additional cryptographically verifiable assets in the first NFT such that the first value of the first NFT increases by an amount equal to the second portion;
generating, by the one or more computing devices, a third NFT comprising the first NFT hash value, wherein a third value of the third NFT is the second portion of the first value; and
issuing, by the one or more computing devices, the third NFT to the different user.

7. The method of claim 1, further comprising:
determining, by the one or more computing devices, that a crypto-value of the at least one cryptographically verifiable asset has changed such that the first value of the first NFT is updated to a new value; and
adjusting, by the one or more computing devices, the new value of the first NFT by adding additional hash values of additional cryptographically verifiable assets in the first NFT or removing at least one hash value of a cryptographically verifiable asset from the first NFT, such that new value is adjusted to equal the first value.

8. A system for generating non-fungible tokens (NFTs) representing digital assets, the system comprising:
a memory; and
a processor coupled to the memory, the processor configured to:
generate a first NFT comprising one or more hash values, each hash value of the one or more hash values corresponding with at least one cryptographically verifiable asset of one or more cryptographically verifiable assets;
receive a first request to obtain a first portion of the first NFT for a user;
determine a first value of the first NFT based on a crypto-value of each of the one or more cryptographically verifiable assets;
generate a second NFT comprising a first NFT hash value, wherein a second value of the second NFT matches the first portion of the first value; and
issue the second NFT to the user.

9. The system of claim 8, wherein the first NFT is represented by a first blockchain and the second NFT is represented by a second blockchain.

10. The system of claim 9, wherein the second blockchain indicates that the second value of the second NFT is equal to the first portion of the first NFT.

11. The system of claim 8, wherein the processor is further configured to adjust the value of the first NFT by adding additional hash values of additional cryptographically verifiable assets to the first NFT or removing at least one hash value of a cryptographically verifiable asset from the first NFT.

12. The system of claim 8, wherein the processor is further configured to:
receive a second request to obtain a second portion of the first NFT from a different user;
determine all portions of the first NFT have been obtained;
generate a third NFT comprising the one or more additional hash values of the one or more cryptographically verifiable assets included in the first NFT, wherein the third NFT is of a third value and the third value matches the first value;
generate a fourth NFT comprising a third NFT hash value, wherein a fourth value of the fourth NFT is the second portion of the third value; and
issue the fourth NFT to the different user.

13. The system of claim 8, wherein the processor is further configured to:
receive a second request to obtain a second portion of the first NFT from a different user;
determine all portions of the first NFT have been obtained;
adjust the first value of the first NFT by adding additional hash values of additional cryptographically verifiable assets in the first NFT such that the first value of the first NFT increases by an amount equal to the second portion; and
generate a third NFT comprising the first NFT hash value, wherein a third value of the third NFT is the second portion of the first value; and
issue the third NFT to the different user.

14. The system of claim 8, wherein the processor is further configured to:
determine that a crypto-value of the at least one cryptographically verifiable asset has changed such that the first value of the first NFT is updated to a new value; and
adjust the new value of the first NFT by adding additional hash values of additional cryptographically verifiable assets in the first NFT or removing at least one hash value of a cryptographically verifiable asset from the first NFT, such that new value is adjusted to equal the first value.

15. A non-transitory computer-readable medium having instructions stored thereon that, when executed by at least one computing device, cause the at least one computing device to perform operations comprising, the operations comprising:
generating a first NFT comprising one or more hash values, each hash value of the one or more hash values corresponding with at least one cryptographically verifiable asset of one or more cryptographically verifiable assets;
receiving a first request to obtain a first portion of the first NFT for a user;
determining a first value of the first NFT based on a crypto-value of each of the one or more cryptographically verifiable assets;
generating a second NFT comprising a first NFT hash value, wherein a second value of the second NFT matches the first portion of the first value; and
issuing the second NFT to the user.

16. The non-transitory computer-readable medium of claim 15, wherein the first NFT is represented by a first blockchain and the second NFT is represented by a second blockchain, and wherein the second blockchain indicates that the second value of the second NFT is equal to the first portion of the first NFT.

17. The non-transitory computer-readable medium of claim 15, wherein the operations further comprise adjusting the value of the first NFT by adding additional hash values of additional cryptographically verifiable assets to the first NFT or removing at least one hash value of a cryptographically verifiable asset from the first NFT.

18. The non-transitory computer-readable medium of claim 15, wherein the operations further comprise:
receiving a second request to obtain a second portion of the first NFT from a different user;
determining all portions of the first NFT have been obtained;
generating a third NFT comprising the one or more additional hash values of the one or more cryptographically verifiable assets included in the first NFT, wherein the third NFT is of a third value and the third value matches the first value;
generating a fourth NFT comprising a third NFT hash value, wherein a fourth value of the fourth NFT is the second portion of the third value; and
issuing the fourth NFT to the different user.

19. The non-transitory computer-readable medium of claim 15, wherein the operations further comprise:
receiving a second request to obtain a second portion of the first NFT from a different user;
determining all portions of the first NFT have been obtained;
adjusting the first value of the first NFT by adding additional hash values of additional cryptographically verifiable assets in the first NFT such that the first value of the first NFT increases by an amount equal to the second portion; and
generating a third NFT comprising the first NFT hash value, wherein a third value of the third NFT is the second portion of the first value; and
issuing the third NFT to the different user.

20. The non-transitory computer-readable medium of claim 20, wherein the operations further comprise:
determining that a crypto-value of the at least one cryptographically verifiable asset has changed such that the first value of the first NFT is updated to a new value; and
adjusting the new value of the first NFT by adding additional hash values of additional cryptographically verifiable assets in the first NFT or removing at least one hash value of a cryptographically verifiable asset from the first NFT, such that new value is adjusted to equal the first value.
